(19) United States
(12) Patent Application Publication
(10) Pub. No.: US 2022/0383398 A1
(43) Pub. Date: Dec. 1, 2022

(54) VIRTUAL, INFERRED, AND DERIVED PLANOGRAMS

(71) Applicant: NCR Corporation, Atlanta, GA (US)

(72) Inventors: Matthew Robert Burris, Atlanta, GA (US); Christopher John Costello, Suwanee, GA (US); Itamar David Laserson, Givat Shmuel (IL); Norman Leonard Trujillo, Frisco, TX (US)

(21) Appl. No.: 17/333,156

(22) Filed: May 28, 2021

(51) Int. Cl. G06Q 30/06; G06N 5/04; H04L 29/06

(52) U.S. Cl. CPC G06Q 30/0643; G06Q 30/0635; G06N 5/04; H04L 67/40

(57) ABSTRACT

A cross-entity and cross-retailer platform is provided that captures transaction data (associated with both in-store or on-line transactions), indexes, and stores the data in a cloud-accessible data store. For any given store of a given retailer, a Virtual Planogram (VP) is maintained for that store. The VP comprises metrics, relationships derived from the metrics, and inferences drawn from the relationships based on item sales and the corresponding transaction data for those item sales. The relationships show the rate of change in item sales over different intervals of time vis-a-vis sales of item categories/departments within the store. The inferences drawn from the relationships show a logical product placement mapping of the items or the proximity of the items to one another within the store. The VP is provided to the retailers and/or entities associated with items of the retailers as an interactive graph within retailer-provided and entity-provided interfaces.

### BACKGROUND

A planogram is a detailed map of each shelf on each aisle with detailed product placement. The planogram drives may activities within retail store operation teams as well as across suppliers, impacting store sales of specific items based on placement as well as impacting the customer shopping experience.

Building, maintaining, and accessing an accurate planogram encounters server real-world problems. A planogram is often created from multiple individual plans developed by the retailer, or more often the supplier, for specific categories or sections for specific stores, store types or regions. The complexity of organizing, implementing planograms, and access rights or securing permissions make gaining access to planograms in a timely manner a significant issue.

Store associates, sometimes with support from suppliers, will arrange store shelves to match the planogram. In the real world, human factors from staff, shoppers, and inventory realities often cause the state of the shelf to deviate from the planned planogram, impacting sales for the entire supply chain of merchandise.

Without integrating the planogram to store sales, shopper basket analysis, and promotional activity such as endcap or in-aisle promotions in near-real time, retailers and suppliers are limited as to how they can detect and respond to merchandise stock depletions, optimize their merchandising decisions—where products should be optimally positioned on shelves—and the effectiveness of endcap placements.

Endcaps are the space at the end of each aisle or the space before entering/existing lanes within a store; endcaps are prized real estate within a store and suppliers/manufacturers/distributors pay handsomely for positioning their products at the endcaps.

### SUMMARY

In various embodiments, methods a system for virtual, inferred, and derived planograms are presented.

According to an embodiment, a method for generating and integrating a virtual planogram within retail environments is presented. As an example, metrics from sales of items at a store are maintained within a data store. Relationships are derived between the metrics and transaction data associated with transactions of the store. Inferences are derived from the relationships as a logical item placement mapping for the items within the store. The metrics, the relationships, and the logical item placement mapping as a Virtual Planogram (VP) for the items of the store.

### BRIEF DESCRIPTION OF THE DRAWINGS

FIG. 1 is a diagram of a system/platform for virtual, inferred, and derived planograms, according to an example embodiment.

FIG. 2 is a diagram of a method generating and integrating a virtual planogram within retail environments, according to an example embodiment.

FIG. 3 is a diagram of another method for generating and integrating a virtual planogram within retail environments, according to an example embodiment.

### DETAILED DESCRIPTION

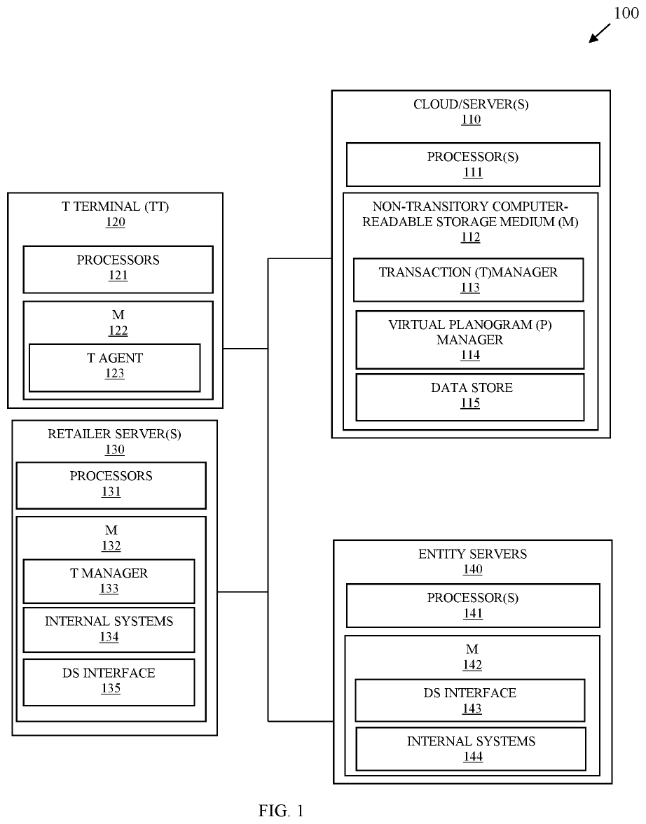

FIG. 1 is a diagram of a cross-entity system/platform 100 for virtual, inferred, and derived planograms, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of the generating and integrating virtual inferred and derived planograms within retail environments, presented herein and below.

System/platform 100 (herein after just “system 100”) provides a processing environment by which entities (e.g., Consumer Product Goods manufacturers (CPGs), item suppliers, item distributors, and item retailers) can obtain real-time valuable store metrics and relationships between item sales metrics and a store's virtual planogram, such as a rate with which an item sales and the item category sales or department sales within the store (such as diary, meat, drinks, bread, frozen meals, etc.), the departments most frequently visited during an in-store shopping trip of a consumer, the most frequented paths taken by a consumer through the store during an in-store shopping trip, the rate or velocity of item sales by departments, dead zones or departments infrequently visited during shopping trips, hot zones for departments based on a sales velocity of particular items, shelf space and/or in-store inventory of a given item based on a larger than anticipated amount of sales for that item within a predefined period of time, etc.

Each transaction at a store comprises a basket of items being purchased (it is to be noted that a basket may comprise a single item being purchased, or multiple items being purchased). The basket of items for a given transaction, provide valuable item identifiers and other information for the items, such as item category, item department, item description, item price, any redeemed item promotion, etc. Thus, the basket can be used to identify the departments visited by a given consumer based on a corresponding item purchased and the basket of items can be used to infer a path or journey of the given consumer through the store during the shopping trip.

Other information available from the store may also be processed and considered as input by system 100, such as picker times for pickers that are fulfilling online transaction orders within the store, shelf or item replenishment notifications, safety stock adjustments based on product resets, product displays that are working, challenges with certain displays and shelf compliance, operating rules of the store, etc.

When multiple transactions are evaluated to assemble the basket-based metrics for a given store and considered with the other information of the store. A virtual, inferred, and derived planogram (herein after just “virtual planogram”) is generated for a given store. Item sales can be aggregated across multiple retailer channels, inventory data, and basket data inventory data. The virtual planogram represents a set of data and relationships provided in a data structure for interface visualization and/or for Application Programming Interface (API) automated processing with internal systems of the retailer and entities associated with the items of the transactions. A given virtual planogram infers information about a given store's actual product layout within the store and proximities of the products to one another within the store provided in a logically generated product proximity mapping data structure or data object.

The virtual planogram for a given store can then be consumed by the retailers and entities for insights and adjustments to item placements within a given store (shelf location, endcap displays, etc.) for purposes of maximizing item sales and the retailer gains valuable information about the traffic patterns within each of their stores to identify areas within the store associated with higher than normal item sales and lower than normal sales, such information may cause the retailer to adjust its existing planogram (if the retailer even has one) based on the provided virtual planogram. In fact, a variety of insights can be derived by the retailers and the entities in partnerships to provide preferred items together using the virtual planogram.

The term “item” may be used interchangeably and synonymously with the terms “product,” “merchandise,” and/or “good.”

As used herein the term “manufacturer” is used to identify a company that manufactures an item/product. A “supplier” is used to identify a company that supplies the item/product of a manufacturer to a distributor; in some instances, the supplier may also be the manufacturer of the item/product. A Consumer-Packaged Goods (CPG) company is an entity that manufacturers the item/product and then provides the item/product directly to a retailer for resale to a consumer. A distributor is used to identify a company that provides the item/product of a manufacturer (or a supplier that is also the manufacturer) directly to a retailer.

As used herein the term “company” or the term “entity” refers to a manufacturer, a supplier, a CPG, and/or a distributor.

The term “retailer” refers to an organization that resells an item/product directly to the consumer.

A “transaction terminal 120” is a type of device that is used to perform transactions, which may also include a variety of integrated peripheral devices or which may be interfaced to peripheral devices. The peripheral devices may comprise card readers, currency/coin acceptors and dispensers, scanners, weigh scales, integrated scanners with weigh scales, touch displays, cameras, etc.

A consumer device may also be considered a transaction terminal 120 when the consumer device is being operated by a consumer for purposes of performing a transaction, such that in some embodiments, the transaction terminal 120 is a phone, a laptop, a desktop, a tablet, a voice-based network-enabled device (Google® Home®, Amazon® Echo®, etc.), etc. Thus, a consumer device where the consumer purchases an item from a retailer via a browser is considered to be a transaction terminal 120 for that purchase that interacts with a retailer server 130 to purchase the item.

A retail staff operated device can also be a transaction terminal 120 when a staff member operates the device for purposes of performing a transaction on behalf of a customer. The staff operated device may be a Point-Of-Sale (POS) terminal, a tablet, a phone, a laptop, or a desktop.

In some cases, a consumer performs a self-checkout via a transaction terminal 120 located within a retail store, such that in these situations the transaction terminal 120 is a Self-Service Terminal (SST) or a kiosk.

System 100 comprises a cloud/server 110, a transaction terminal 120, retailer servers 130, and entity servers 140.

Cloud/Server 110 comprises at least one processor 111 and a non-transitory computer-readable storage medium 112. Medium 112 comprises executable instructions for transaction manager 113, virtual planogram (VP) manager 114, and a data store 115 (the data store 115 residing in medium 112 and comprising executable instructions for querying and mining the data store 115). The executable instructions when provided to processor 111 from medium 112 cause processor 111 to perform the processing described herein and below with respect to 113-115.

Transaction terminal 120 comprises at least one processor 121 and a non-transitory computer-readable storage medium 122. Medium 122 comprises executable instructions for transaction agent 123. The executable instructions when provided to processor 121 cause processor 121 to perform the processing described herein and below with respect to agent 123.

Each retailer server 130 comprises one or more processors 131 and non-transitory computer-readable storage medium 132. Medium 132 comprises executable instructions for transaction manager 133, internal systems 134, and a data store interface 135. The executable instructions when provided to one or more processors 131 from medium 132 cause processors 131 to perform the processing described herein and below with respect to 133-135.

Each entity server 140 comprises one or more processors 141 and non-transitory computer-readable storage medium 142. Medium 142 comprises executable instructions for a data store interface 143 and internal systems 144. The executable instructions when provided to one or more processors 141 from medium 142 cause processors 141 to perform the processing described herein and below with respect to 143-144.

Terminal 120 performs transactions for selling items. Transaction agent 123 of retailer server 130 processes a transaction purchase workflow that interacts with transaction manager 133 for purposes of completing a transaction to sell one or more items to a consumer on behalf of a retailer at the retailer store or online (via a web-based or app-based interface—online transactions may utilize a consumer device as terminal 120 (such as consumer phone, tablet, laptop, desktop, etc.)).

Transaction agent 123 combined with internal systems 134 of each retailer may also combine to provide relevant information from online transactions that are scheduled for pickup or delivery. The transaction information of any order is provided by transaction agent 120 and transaction manager 133 and the picker information (staff member that fulfills the order by picking the items from the shelves), such as start pick time, end pick time, picker identifier, time of day, day of week, calendar date, season of year, etc. is provided by one of the retailer's internal systems 134.

Transaction manager 133 processes purchase transaction workflows through interaction with transaction agent 123. The purchase transaction workflow is enhanced and modified with the teachings presented herein, such that during purchase transaction, transaction manager 133 notifies transaction manager 113 of the transaction along with transaction data (may also be referred to as transaction details). The transaction data is gathered by transaction agent 123, by transaction manager 133, and any picker information gathered by internal fulfillment system 134 when an online transaction is being picked or fulfilled. Additional transaction data may also be provided by transaction manager 133 for each retailer's transaction using as product/item catalogue, and/or customer loyalty data stores.

Transaction data may comprise, a customer identifier (if available) for the customer associated with the transaction, a customer profile (if available) associated with the customer identifier, item codes for each item (such as Universal Product Code (UPC)) of the transaction, item pricing for each item of the transaction, item category for each item of the transaction, item description for each item of the transaction, a transaction type that identifies an item return transaction versus a purchase transaction, a channel identifier for a channel being used for the transaction (e.g., in person at a POS terminal 120, in person at a SST 120, online via a consumer device acting as terminal 120 through a mobile application of the consumer device, online via a specific e-commerce system using a browser, via a call center through an agent that operates a terminal 120, etc.), transaction identifier for the purchase transaction of all of the items being purchased by the customer, a terminal identifier for the terminal 120, a store identifier for the store associated with the item return, geographical location data for the store, any available planogram data for shelf locations of the items associated with the transaction within the store (note that this may not be provided and may not exist and is not needed with the embodiments herein but if it is available it can be included in the transaction data or augmented by the transaction manager 133 to be included with the transaction data), a retailer identifier for the retailer, a transaction history for the customer (if available), entity identifiers for the manufacturer, supplier, distributor, and/or CPG associated with the item codes (there may be one to several entity identifiers for a single item being purchased with the transaction), customer demographic data or customer segmentation data for the customer maintained in the loyalty data store (if available), calendar date for the item return, day of the week for the item return, time of day for the item return, a season associated with the calendar date, promotion identifiers for any promotions redeemed with the items of the transaction, promotion details for each redeemed promotion during the transaction, etc.

It is to be noted also terminal 120 may be a mobile device operated by the consumer (consumer device), such that the mobile device reports through transaction agent 123 a current geographical location of the mobile device using the device's location services.

Moreover, transaction data may comprise additional information available to retailer from their data stores or internal systems 134 from what was presented above or less information from what was presented above.

Further, customer profile data (when available) of the may comprise customer contact information (such as mobile device number, email address, social media identifiers, etc.), customer name, customer loyalty level, preferred contact channel of customer (e.g., via email, text, and/or voice call).

Transaction manager 133 sends a transaction identifier for the transaction in real time along with the transaction data/details to transaction manager 113 of cloud 110 as items are purchased and the transaction is processed on terminal 120 and a fulfillment system 134 sends any available picker information/data to transaction manager 113 for the transaction so that the picker data is supplied for the transaction with the transaction data.

Transaction manager 113 indexes, links, and stores the transaction data and any picker data within data store 115 based on the retailer identifier for the retailer, e-commerce system identifier (if available for the entity that took a customer's online order associated with the transaction), store identifier, item categories or item types for each item of the transaction, the entity identifiers (for the manufacturer, supplier, distributor, and/or CPG) associated with each entity of each item of the transaction, the items' identifiers (UPCs) for the purchased items of the transaction, any promotion identifiers for any promotions redeemed during the transaction, and/or a customer identifier for the customer (if available).

Each record in data store 115 comprises transaction data or transaction details and any available picker information for the corresponding purchase transaction. Furthermore, some retailers may comprise their own unique entity identifiers for distributors or suppliers, such that transaction/return manager 113 may maintain lookup tables that map a given distributor's or a given supplier's retail-specific entity identifier and associate it to a unique entity identifier for the given distributor or supplier maintained by cloud 110. The manufacturer of the purchased items are already assigned unique manufacturer identifiers available within the UPCs (item codes) of the transaction data for the transaction.

In some embodiments, mapping tables to distinguish unique customer identifiers across retailers may also be used by transaction/return manager 113 for purposes of identifying a unique customer across different retailers that is associated with different retailer-assigned customer identifiers. In this embodiment, a globally unique customer identifier for a customer may be maintained and managed by transaction manager 113 across a plurality of retailers.

Each transaction record of the data store 115 represents a single basket of items (again, can be a basket of 1 items) that was processed for a given retailer at a given store or fulfilled at the store by a picker.

VP manager 114 is notified when records are added to the data store 115. At predefined or configured intervals of time, based on a volume of records added to data store 115, and/or each time a transaction is completed and a record is added to data store 115, VP manager 114 mines the records associated with any given retailer and/or any given store and generates or updates a given VP for the given store based on the added transaction records and other transaction records for other transactions of the given store.

For a current transaction record of a given store, VP manager 114 obtains the item identifiers for the basket of items included within the transaction data of the current record and obtains the item categories and item departments that correspond to the item identifiers. An aggregated total for each item sold and its item category and item department are maintained over a given interval of time (for example for a past month, past week, past quarter, past 2 days, etc.). A historical total for each past interval of time is also maintained. For example, a week item X was sold at prices that varied for a total of sales price of N, item X is in item category Y and store department Z; each of the previous 51 weeks of the year also include their corresponding aggregated totals for item X and N.

VP manager 114 also maintains with each interval (current and past intervals) a variety of other aggregated interval totals such as average pick time for online orders fulfilled during the interval, total number of online orders for the interval, item shelf replenishment notifications during the period, item display replenishment notifications, item safety stock adjustments, item challenges or issues recorded with item displays, etc.

The aggregated totals for the current interval and the previous intervals for the item, the item category as a whole, and the item department as a whole are then plotted on a graph or mathematically analyzed over intervals of time (current interval and past recorded intervals). This shows total sales of the item versus total sales of the item category versus the total sales of the item department over time with the current interval of time. Another graphing or mathematical analysis of each item categories (all items within a category) and of each item department (all items of all item categories within a department) is produced by the VP manager 114. This shows total sales from item categories and item departments over time with the current interval of time.

The graphs or the mathematical analysis allows VP manager 114 to derive relationships from the captured metrics/aggregated totals over time vis-vis the current interval of time, such as a current rate and changed rate over time for a given item's sales as a percentage of the category sales for the item category of the item and as a percentage of department sales for the item department associated with the item category within a given, the departments most frequently visited during an in-store shopping trip of a consumer, the most frequented paths taken by a consumer through the store during an in-store shopping trip, the rate or velocity of item sales by departments, dead zones or departments infrequently visited during shopping trips, hot zones for departments based on a sales velocity of particular items, shelf space and/or in-store inventory of a given item based on a larger than anticipated amount of sales for that item within the current interval.

Inferences can be drawn about the proximity of the items to one another within the store based on the relationships, such as based on an item's current rate of sales being above a threshold in the current interval that is above an average rate of sales for the item over the previous intervals with the current rate of sales matching (within another threshold) closely to another item's current rate of sales associated with a different department then the item. Here, the inference is that an evaluated item was moved from its original department location to an endcap location within the store adjacent to a different department. The proximity of the item relative to other items can be inferred based on the current rate of sales analysis and the item location inferred (endcap) based on the current rate of sales exceeding a threshold of that same item's average rate of sales over the previous intervals. Furthermore, a precipitous decline in an item's sales rate in the current interval when compared to an average sales rate for the item of the previous intervals may infer that the item was moved from an endcap location during the current interval of time and placed back in its department in its original shelf location. Based on sales rates of other items for the same item category and same item department it may be further assumed that the evaluated item is proximate to other items within the category or within the department. The inferences represent a logical item placement map or mapping provided in the VP.

The VP manager 114 generates or updates an existing VP for the given store with the relationships, the graphs, and calculated metric/aggregated totals from the graphs, such as current top selling items, item categories, and departments for the current interval; low selling items, item categories, and departments for the current interval of time; average picker time for current interval versus average picker time for previous intervals; increase or decrease in online transactions versus in-store transactions (based on channel identifier maintained with the transaction records); most redeemed promotion overall and by channel, least redeemed promotion overall and by channel, most common purchased basket of items for the transactions of the current interval (for example there were a total of N transactions that comprised, milk, eggs, butter, and bread); most frequently replenished item on shelves or displays within the current interval, lest frequency replenished item or items on shelves or displays, etc.

The VP manager 114 then provides the generated or updated VP as a data structure or data object to interfaces 135 and 143. The VP comprises the metrics/aggregated totals, graphs for the current interval and previous intervals, and the relationships and inferences drawn from the graphs. The VP can be visualized within a graph when rendered within interfaces 135 and 143 and interacted with to drill down into specific desired metrics/aggregated totals through interactions of the retailers and the entities. The graph can also be interacted with to roll up to higher or more coarse-grain metrics/aggregated totals.

Each retailer and entity may also comprise its own workflow, such that with each additional record added to data store 115, VP manager 114 obtains that retailer's or that entity's workflow and processes the corresponding workflow. VP manager 114 pulls the transaction records that span multiple channels, retailers, and entities associated with the reporting interval along with the metrics/aggregated totals retained for the previous intervals and updates the current metrics/aggregated totals for the current interval, compares to the metrics/aggregated totals of the previous intervals, derives or updates new relationships, derives or updates current inferences (logical item proximity map) regarding each item's placement or proximity within a given store to other items of the store, and generates or updates a current VP for the store. The retailer or entity may custom within their workflows the thresholds or rate of change detected in the relationships that dictate immediate report out of the VP to the corresponding retailer or the corresponding entity. In an embodiment, each retailer or each entity may also custom defined specific relationships or specific metrics to capture, such as a rate of change of redeemed promotions as a whole during the current interval when compared to a previous interval, etc. The VP manager 114 uses the generated or updated VP and the existing transaction data along with other transaction data associated with other transactions of the given store to process each of the conditions of the retailer's workflow.

In some instances, the conditions evaluated within a given workflow may report that a current aggregated total for a given metric, a current relationship, a current inference, and/or select data from the transaction data be reported in real time to an internal system 134 using an API specific to internal system 134 (for example an inventory system 134 when more items are required in inventory to meet the current demand; roll back a given promotion when the redemption rate exceeds a threshold; etc.) If the workflow being processed is for an entity associated with one of the items in a current transaction, VP manager 114 in accordance with conditions of the entity's workflow may automatically and immediately report out a current aggregated total for a given metric, a current relationship, a current inference, and/or select data from the transaction data in real time to an internal system 144 using an API.

Each entity/retailer workflow can custom define what event, what aggregated total for what tracked metric (per channel), what relationship, and/or what inference triggers an automated report out by VP manager 114 to internal systems 134 and 144. Specific retailer/entity defined conditions, events, and time intervals can also be defined before an automated report out is triggered.

The internal systems 134 and 144 may comprising inventory systems, loyalty/promotion systems, schedule/delivery systems, ordering systems, etc. This allows for integration of real-time purchase transactions within each internal system 134 and 144.

Thus, VP manager 114 acts as a real-time monitor of purchase transactions for each interested retailer and entity and when retailer/entity-defined conditions of workflows are met based on generated or updated VPs, the VPs are rendered to interfaces 135 and 142 and/or select portions of the VPs are automatically reported to internal systems 134 and 144. This allows real-time item store placement decisions to be made by the retailers and the entities in cooperation with the retailers, real-time promotions decisions to be made, real-time inventory decisions to be made, and real-time item manufacturing and ordering decisions to be made, etc.

System/Platform 100 is completely automated and processed in real time and is employed via data store 115. Data store 115 is maintained and custom mined (based on each retailer's/entity's purchase transaction workflow) by transaction/return manager 113 and VP manager 114 to generate and update VPs for stores of the retailers. At the same time, VP manager 114 continuously updates existing VPs with each new transaction at the stores such that each VP reflects current metrics, relationships, and inferences for the items of the stores. VP manager 114 delivers the VPs to the corresponding retailers and entities via interfaces 135 and 143 when needed (based on tracked metrics, deviations in relationships, new or revised inferences between reporting periods defined within custom workflows for the retailers and entities and/or at the end of each reporting interval).

Additionally, both the retailers and the entities can access data store 115 and perform queries and generate reports via interface 135 of retailer servers 130 and via interface 143 of entity servers 140. That is, a user-facing interface to VP manager 114 is provided through interface 135 to the retailers and is provided through interface 143 to the entities. The retailers and entities can provide custom search criteria through the user-facing interface to VP manager 114. VP manager 114 then processes the search criteria against data store 115 and returns search results back to the entities or retailers via interfaces 143 and 135. VP manager 114 may also permit queries against the VPs through interfaces 135 and 143.

It is to be noted that data store 115 can be organized in any number of manners, such as via tables by retailer, tables by store of retailer, tables by entity, tables by type of item, etc. When VP manager 114 processes the workflows, the appropriate tables needed that span multiple different retailers/entities or that are associated with just one retailer/entity or store of the retailer can be searched selectively. In this manner, transaction identifiers are unique for a given retailer or a given store within a given table, but the VP manager 114 can search across multiple different tables associated with multiple different retailers/entities when conditions defined in a retailer/entity workflow dictate.

Each entity or retailer can have custom workflows for both item returns and purchase transactions. For example, an entity may have an item return workflow that notifies transaction manager 133 when a predefined total of number of items of a specific type are returned within an entity-set period of time over each of the channels. This can assist the entity in truck load planning and truck route planning. This is but one example and it is to be understood that a variety of retailer and entity-based needs can drive their item return workflows and purchase transaction workflows. Furthermore, the channel-based trends/patterns can be defined within the item return workflow similar to what was discussed above for the purchase transaction workflows, such that channel-based trends/patterns are discovered and reported for both purchase transactions and item returns.

Transaction manager 113, VP manager 114, and data store 115 collective present and provide an up-to-date VP to the retailers and the entities (providing the features and functions discussed herein). This allows retailers and entities to collaborate and to optimize item placement within a given store, item promotions, and item order/manufacture schedules.

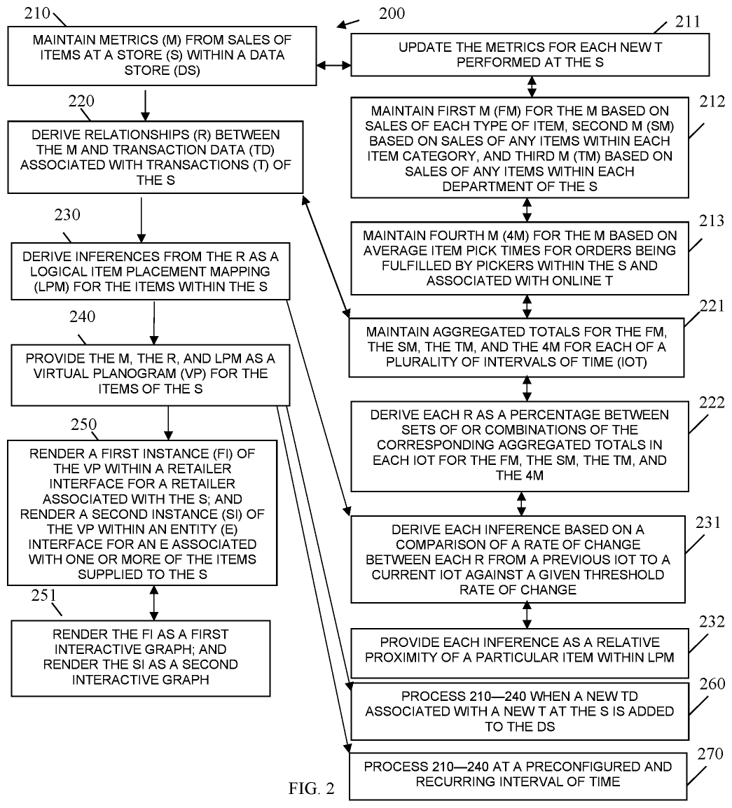

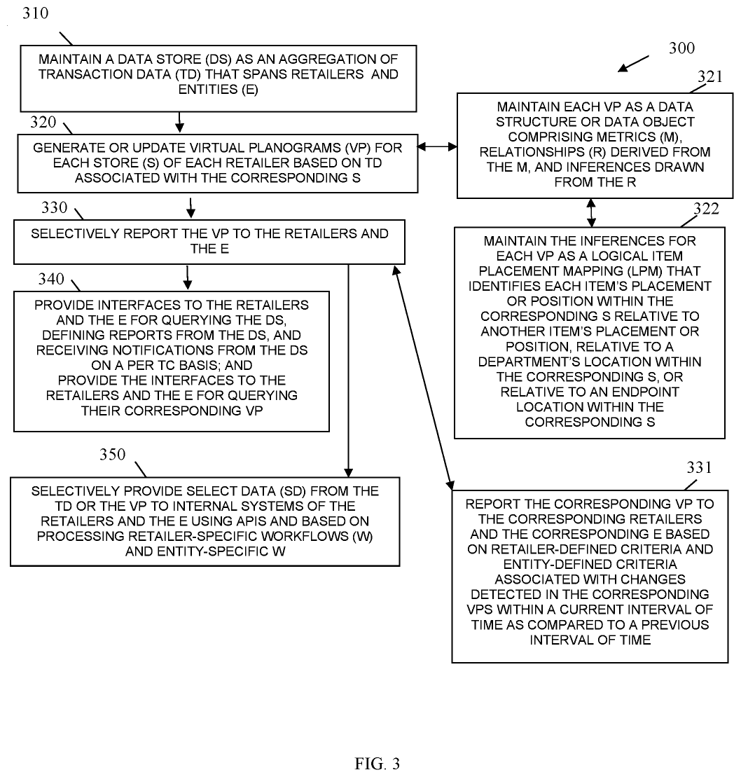

These and other embodiments are now discussed with reference to FIGS. 2-3.

FIG. 2 is a diagram of a method 200 for generating and integrating a virtual planogram within retail environments, according to an example embodiment. The software module(s) that implements the method 200 is referred to as a “VP manager.” The VP manager is implemented as executable instructions programmed and residing within memory and/or a non-transitory computer-readable (processor-readable) storage medium and executed by one or more processors of one or more devices. The processor(s) of the device that executes the VP manager are specifically configured and programmed to process the VP manager. The VP manager may have access to one or more network connections during its processing. The network connections can be wired, wireless, or a combination of wired and wireless.

In an embodiment, the device that executes the VP manager is cloud 110. In an embodiment, cloud 110 comprises a plurality of servers logically cooperating and accessible as a single server 110 (cloud 110).

In an embodiment, the VP manager is all or some combination of 113-115.

At 210, the VP manager maintains metrics from sales of items at a store within a data store 115.

In an embodiment, at 211, the cloud-based cross entity and cross retailer VP service updates the metrics for each new transaction performed at the store.

In an embodiment of 211 and at 212, the cloud-based cross entity and cross retailer VP service maintains first metrics based on sales of each type of item, second metrics based on sales of any items within each item category available at the store, and third metrics based on sales of any items with each department of the store.

In an embodiment of 212 and at 213, the cloud-based cross entity and cross retailer VP service maintains fourth metrics based on average item pick times for orders being fulfilled by pickers within the store and associated with online transactions.

At 220, the cloud-based cross entity and cross retailer VP service derives relationships between the metrics and transaction data of the data store that is associated with transactions of the store.

In an embodiment of 213 and 220, at 221, the cloud-based cross entity and cross retailer VP service maintains aggregated totals for the first metrics, the second metrics, the third metrics, and the fourth metrics for each of a plurality of intervals of time.

In an embodiment of 221 and at 222, the cloud-based cross entity and cross retailer VP service derives each relationship as a percentage between sets of or combinations of the corresponding aggregated totals in each interval of time for the first metrics, the second metrics, the third metrics, and the fourth metrics.

At 230, the cloud-based cross entity and cross retailer VP service derives inferences from the relationships as a logical item placement mapping for the items within the store.

In an embodiment of 222 and 230, at 231, the cloud-based cross entity and cross retailer VP service derives each inference based on a comparison of a rate of change between each relationship from a previous interval of time to a current interval of time against a given threshold rate of change.

In an embodiment of 231 and at 232, the cloud-based cross entity and cross retailer VP service provides each inference as a relative proximity or relative position of a particular item to another item within the store, to a department within the store, or to an endpoint location within the logical item placement mapping.

At 240, the cloud-based cross entity and cross retailer VP service provides the metrics, the relationships, and the logical item placement mapping as a VP for items of the store.

In an embodiment, at 250, the cloud-based cross entity and cross retailer VP service renders a first instance of the VP within a retailer interface for a retailer associated with the store. The cloud-based cross entity and cross retailer VP service also renders a second instance of the VP within an entity interface for an entity associated with one or more of the items supplied to the store.

In an embodiment of 250 and at 251, the cloud-based cross entity and cross retailer VP service renders the first instance as a first interactive graph and renders the second instance as a second interactive graph.

FIG. 3 is a diagram of another method 300 for generating and integrating a virtual planogram within retail environments, according to an example embodiment. The software module(s) that implements the method 300 is referred to as a “cloud-based cross entity and cross retailer VP service.” The cloud-based cross entity and cross retailer VP service is implemented as executable instructions programmed and residing within memory and/or a non-transitory computer-readable (processor-readable) storage medium and executed by one or more processors of a device. The processors that execute the cloud-based cross entity and cross retailer VP service are specifically configured and programmed for processing the cloud-based cross entity and cross retailer VP service. The cloud-based cross entity and cross retailer VP service may have access to one or more network connections during its processing. The network connections can be wired, wireless, or a combination of wired and wireless.

In an embodiment, the device that executes the cloud-based cross entity and cross retailer VP service is cloud 110. In an embodiment, the device that executes the item return transaction integration manager is server 110.

In an embodiment, the cloud-based cross entity and cross retailer VP service is all of or some combination of 113-115 and/or method 200 of FIG. 2.

The cloud-based cross entity and cross retailer VP service presents another and, in some ways, enhanced processing perspective of the what was discussed above for cloud 110 and method 200.

At 310, the cloud-based cross entity and cross retailer VP service maintains a data store as an aggregation of transaction data that spans retailers and entities.

At 320, the cloud-based cross entity and cross retailer VP service generates or updates VPs for each store of each retailer based on transaction data associated with the corresponding store.

In an embodiment, at 321, the cloud-based cross entity and cross retailer VP service maintains each VP as a data structure or as a data object that comprises metrics, relationships derived from the metrics, and inferences drawn from the relationships.

In an embodiment of 321 and at 322, the cloud-based cross entity and cross retailer VP service maintains the inferences for each VP as a logical item placement/proximity mapping that identifies each item's placement/position/proximity within the corresponding store relative to another item's placement/position/proximity, relative to a department's location within the corresponding store, or relative to an endpoint's location within the corresponding store.

At 330, the cloud-based cross entity and cross retailer VP service selectively reports the VPs to the retailers and the entities.

In an embodiment, at 331, the cloud-based cross entity and cross retailer VP service reports the corresponding VPs to the corresponding retailers and the corresponding entities based on retailer-defined criteria and entity-defined criteria associated with changes detected in the corresponding VPs within a current interval of time as compared to a previous interval of time.

In an embodiment, at 340, the cloud-based cross entity and cross retailer VP service provides interfaces to the retailers and the entities for querying the data store, defining reports from the data store, and receiving notifications from the data store. Moreover, the cloud-based cross entity and cross retailer VP service provides the interfaces to the retailers and the entities for querying their corresponding VPs.

In an embodiment, at 350, the cloud-based cross entity and cross retailer VP service selectively provides select data from the transaction data or the VP to internal systems of the retailers and the entities using APIs and based on processing retailer-specific workflows and entity-specific workflows.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
maintaining metrics from sales of items at a store within a data store;
deriving relationships between the metrics and transaction data associated with transactions of the store;
deriving inferences from the relationships as a logical item placement mapping for the items within the store; and
providing the metrics, the relationships, and the logical item placement mapping as a Virtual Planogram (VP) for the items of the store.

2. The method of claim 1 further comprising:
rendering a first instance of the VP within a retail interface for a retailer associated with the store; and
rendering a second instance the VP within an entity interface for an entity associated with one or more of the items supplied to the store.

3. The method of claim 2 further comprising:
rendering the first instance as a first interactive graph; and
rendering the second instance as a second interactive graph.

4. The method of claim 1 further comprising:
processing the method when new transaction data associated with a new transaction is added to the data store.

5. The method of claim 1 further comprising:
processing the method at a preconfigured interval of time.

6. The method of claim 1, wherein maintaining further includes updating the metrics for each new transaction performed at the store.

7. The method of claim 6, wherein maintaining further includes maintaining first metrics for the metrics based on sales of each type of item, second metrics for the metrics based on sales of any items within each item category, and third metrics for the metrics based on sales of any items within each department of the store.

8. The method of claim 7, wherein maintaining further includes maintaining fourth metrics for the metrics based on average item pick times for orders being fulfilled by pickers within the store and associated with online transactions.

9. The method of claim 8, wherein deriving the relationships further includes maintaining aggregated totals for the first metrics, the second metrics, the third metrics, and the fourth metrics for each of a plurality of intervals of time.

10. The method of claim 9, wherein maintaining the aggregated totals further includes deriving each relationship as a percentage between sets of or combinations of the corresponding aggregated totals in each interval of time for first metrics, the second metrics, the third metrics, and the fourth metrics.

11. The method of claim 10, wherein deriving the inferences further includes deriving each inference based on a comparison of a rate of change between each relationship from a previous interval of time to a current interval of time against a given threshold rate of change.

12. The method of claim 1, wherein deriving each inference further includes providing each inference as a relative proximity of a particular item to at least one other item, to at least one department, or to an endpoint of the store within the logical item placement mapping.

13. A method, comprising:
maintaining a data store as an aggregation of transaction data that spans retailers and entities, wherein the entities comprise manufacturers, suppliers, distributors, and Consumer Packaging Goods (CPG) companies associated with items that are sold by the retailers to consumers of the retailers;
generating or updating Virtual Planograms (VPs) for each store of each retailer based on the transaction data associated with the corresponding store; and
selectively reporting the VPs to the retailers and the entities.

14. The method of claim 13 further comprising:
providing interfaces to the retailers and the entities for querying the data store, defining reports from the data store, and receiving notifications from the data store on a per transaction channel basis; and
providing the interfaces to the retailers and the entities for querying their corresponding VPs.

15. The method of claim 13 further comprising:
selectively providing select data from the transaction data or the VPs to internal systems of the retailers and the entities using Application Programming Interfaces (APIs) and based on processing retailer-specific workflows for the retailers and based on processing entity-specific workflows for the entities.

16. The method of claim 13, wherein generating or updating further includes maintaining each VP as a data structure or data object comprising metrics, relationships derived from the metrics, and inferences drawn from select ones of the relationships.

17. The method of claim 16, wherein maintaining each VP further includes maintaining the inferences for each VP as a logical item placement mapping that identifies each item's placement or position within the corresponding store relative to another item's placement or position, relative to a department's location within the corresponding store, or relative to an endpoint location within the corresponding store.

18. The method of claim 13, wherein selectively reporting further includes reporting the corresponding VPs to the corresponding retailers and the corresponding entities based on retailer-defined criteria and entity-defined criteria associated with changes detected in the corresponding VPs within a current interval of time as compared to a previous interval of time.

19. A system, comprising:
a cloud processing environment comprising at least one server;
the at least one server comprising a processor and a non-transitory computer-readable storage medium;
the non-transitory computer-readable storage medium comprises executable instructions; and
the executable instructions when executed on the processor from the non-transitory computer-readable storage medium cause the processor to perform operations comprising:
maintaining a data store comprising transaction data for transactions, wherein the transaction data spans multiple retailers and entities, wherein the entities comprise manufacturers, suppliers, distributors, and Consumer Packaging Goods (CPG) companies associated with items that are sold by the retailers to consumers of the retailers;
generating and maintaining Virtual Planograms (VPs) for stores of the retailers from the transaction data of the data store, wherein each VP comprises metrics, relationships derived from the metrics, and inferences drawn from the metrics that provide a logical item placement mapping for items' locations relative to each other, relative to departments, or relative to endpoints of the corresponding store;
selectively providing VPs to the retailers and the entities through interfaces as instances of interactive graphs.

20. The system of claim 19, wherein the executable instructions when executed on the processor from the non-transitory computer-readable storage medium further cause the processor to perform additional operations comprising:
identifying within the interactive graphs hot zones and dead zones with the stores, wherein the hot zones comprise item sales that are above a first threshold and the dead zones comprise item sales that are below a second threshold.
